(19) United States
(12) Patent Application Publication
(10) Pub. No.: US 2005/0246712 A1
(43) Pub. Date: Nov. 3, 2005

(54) Method of designing a system for real time digital signal processing, in which the system uses a virtual machine layer

(75) Inventor: Gavin Robert Ferris, London (GB)

Correspondence Address: SYNNESTVEDT LECHNER & WOODBRIDGE LLP, P O BOX 592, PRINCETON, NJ, 08542-0592, US

(73) Assignee: Radioscape Limited, London (GB)

(21) Appl. No.: 10/515,489

(22) PCT Filed: May 27, 2003
(86) PCT No.: PCT/GB03/02297

§ 371 Date: Jun. 6, 2005

(30) Foreign Application Priority Data
May 27, 2002 (GB) 0212172.1
May 27, 2002 (GB) 0212176.2

(51) Int. Cl. G06F 9/44

(52) U.S. Cl. 719/310; 718/1

(57) ABSTRACT

A method of designing a system for real time digital signal processing, in which the system uses a virtual machine layer to separate (i) high resource functions from (ii) low resource control code that requests execution of the high resource functions, wherein the method comprises the step of partioning the system along its scheduling boundaries and assigning a software entity (“a plane”) to each partioned area such that scheduling is performed in respect of planes. The present invention enables a highly structured approach to system design.

### BACKGROUND OF THE INVENTION

1. Field of the Invention

This invention relates to a method of designing a system for real time digital signal processing, in which the system uses a virtual machine layer.

2. Description of the Prior Art

Modem communications system developers are encountering a number of challenges:
The new radio standards, such as UMTS, are more complex than any previous standards.
Handset developers now have to cope with multiple standards, such as GSM and UMTS, on the same DSP. Consequently there is an increasing need for multi-system integration, where communications stacks from more than one standard have to live side by side on the same platform.
In a typical design flow the tools do not work together well, which means that engineers are forced to make hardware choices early on in the product development cycle.
The existing design flows are flawed, since tools in the design flow do not work together well and are hard to use.
Hardware and software systems are becoming increasingly complex, requiring the use of large development teams, often in different geographical locations.
Modern communications standards and the applications they are used for are operating in a packet-based rather than stream-based mode. This bursty processing challenges the traditional scheduling approaches of embedded engineering.
Within infrastructure equipment there is a need for scalability of the developed solutions.
As hardware platforms and new communication standards and applications continue to evolve at a rapid pace, so the need for flexibility, portability and re-usability of the solutions produced becomes more imperative.
The pressures for rapid delivery of end-product to market and for minimising the fixed costs within that product remain as constant and as strong as ever.
As the system developments become larger the value of an early validation (or rebuttal) of the system design is of increasing value to the developments.
Engineers must continue to confront the constraints present within hard real-time systems, while at the same time minimising overall system cost by reducing the number of components.

The present invention is an element in a larger solution to the above problems, called the Communications Virtual Machine (“CVM™”) from Radioscape Limited of London, United Kingdom. Reference may be made to PCT/GB01/00273 and to PCT/GB01/00278.

### SUMMARY OF THE INVENTION

The present invention, in a first aspect, is a method of designing a system for real time digital signal processing, in which the system uses a virtual machine layer to separate (i) high resource functions from (ii) low resource control code that requests execution of the high resource functions, wherein the method comprises the step of partioning the system along its scheduling boundaries and assigning a software entity (“a plane”) to each partioned area such that scheduling is performed in respect of planes.

The scheduling boundaries may comprise one or more of the following: framing, timing, and instantiation boundaries

The planes communicate with one another asynchronously using messages. A plane can process only one message at a time and pending messages for that plane are queued.

The present invention enables a highly structured approach to system design; it is implemented in the CVM design and run-time system from Radioscape Limited, of London, United Kingdom.

When designing a CVM system, the first step is to analyse the data flow, and on the basis of this, to partition the system into the set of planes. The set of planes, and the messages by which they communicate, is known as a framework.

A framework is a set of single-threaded elements that communicate by asynchronous message passing. These elements are called planes.

Each plane is represented in a framework by a blueprint. A blueprint is analogous to a factory in object-oriented programming. It determines how many instances of a plane are instantiated when the CVM system first starts up, and how many may be instantiated when it is running.

In order that the design can be broken down into modular layers, each plane can be sub-divided into a number of these elements:
modules
engines
drivers

In more specific terms, each plane may contain a single module, which in turn can contain any number of sub-modules, engines and drivers.

Modules provide the link between the asynchronous message-passing activity of planes and the synchronous high-resource processing activity of engines. Engines are encapsulations of intensive data processing functions that are typically targeted for a specific platform.

Both modules and engines have an accompanying procedural programming API which enables you to write the code for the two main methods within each module or engine:
a Configure method, to set up the initial state
a Process method, to perform data processing

The other type of element that can form part of a module is the driver. A driver enables a plane to interact with the hardware on which it is deployed. So, any sources, sinks or hardware engines in your system are likely to require a driver so that the controlling plane can communicate with them.

Enabling planes to communicate with each other are messages. CVM's in-built scheduler decides when to execute those planes that have messages waiting to be processed. Within a plane, only one thread can be in execution.

Other key features are:
all messages are time stamped and identified to a time domain.
there are separate data and control paths between planes.
modules in a plane communicate synchronously.
a module encapsulates an imperative, single threaded data flow path.
planes can be dynamically created and destroyed.
one or more of the following standardised, pre-fabricated planes are available to the designer:
   (a) multiplexing;
   (b) demultiplexing;
   (c) multicast;
   (d) routing;
   (e) active source;
   (f) active sinks.

In another aspect, there is a device capable of real time digital signal processing, in which the device uses a virtual machine layer to separate (i) high resource functions from (ii) low resource control code that requests execution of the high resource functions, wherein the device comprises has been partioned along its scheduling boundaries and a software entity (“a plane”) has been assigned to each partioned area such that scheduling is performed in respect of planes.

### BRIEF DESCRIPTION OF THE DRAWINGS

The present invention will be described with reference to the accompanying Figures, in which:

FIG. 1—illustrates the point that without CVM, high resource functions have unknown resource requirements, fuzzy behaviour, and non-standard inbound and outbound interfaces;

FIG. 2—illustrates the point that CVM engines have known resource requirements, conformed behaviour, standardised interfaces, making them genuinely commoditized components;

FIG. 3—shows that the CVM runtime provides resource management and scheduling, decoupling executives from engines;

FIG. 4—is a CVM design flow summary;

FIG. 5 is a schematic representation of a plane;

FIG. 6 is a screen shot from RadioScape's System Designer IDE (Integrated Development Environment) showing a blueprint;

FIG. 7 is a screen shot from System Designer showing a framework;

FIG. 8—is a screen shot from System Designer showing a framework;

FIG. 9 is a screen shot from System Designer showing XML automatically generated from the FIG. 8 system;

FIG. 10 depicts how cardinality is specified on a blueprint;

FIG. 11 is a screen shot from System Designer showing a plane interface;

FIG. 12 is a screen shot from System Designer showing XML automatically generated from the FIG. 11 system;

FIG. 13 is a screen shot from System Designer showing a module interface for a DAB case study (case study itself is not included);

FIG. 14 is a screen shot from System Designer showing a module interface;

FIG. 15 schematically depicts the inter-relationship between the module interface, module and module deployment files.

### DETAILED DESCRIPTION

The present invention enables a highly structured approach to system design; it is implemented in the CVM design and run-time system from Radioscape Limited, of London, United Kingdom.

1. Overview of the Communication Virtual Machine (CVM)

The CVM is a combination of run-time middleware and design-time tools that together help users implement a development paradigm for complex communication stacks.

The underlying conceptual model for CVM is as follows. We assume that a communication stack (particularly at layer 1) may be decomposed into:
High-resource, largely-application-neutral components, which will probably be implemented either in dedicated hardware or in highly platform-optimised software. These we call engines, and examples would be: FFT, FIR filter, vector multiply, etc. In the general case (where the particular CVM engine constraints are not met), we refer to such blocks as high-resource functions, or HRFs.
Low-resource, largely application-specific components, which will probably contain nothing that inherently binds them to a particular underlying hardware substrate. These we call executives, and examples would be the overall dataflow expression of a data plane, the acquisition and tracking logic in a supervisory plane, and the channel construction and deletion logic in a control plane. In the general case (where the particular CVM executive constraints are not met), we refer to such software as low-resource control code, or LRCC.
The real time operating system (RTOS), which partially shields the software from the underlying hardware platform.

Unfortunately, most system designs have tended to centre around a ‘silo’ paradigm, according to which assumptions about HRF implementation, resource usage, call format and behaviour have been allowed to ‘leak out’ into the rest of the design. This has led to a number of quite unpleasant design practices taking root, all under the banner of efficiency. For example, knowing how long various HRFs will take to execute (in terms of cycles), and how much scratch memory each will require, it often becomes possible for the system designer to write a static schedule for scratch, allowing a common buffer e.g. to be used by multiple routines that do not overlap in time, thereby avoiding potentially expensive and non-deterministic calls to malloc( ) and free( ). However, such a design also tends to be highly fragile; should any of the HRFs be re-implemented (causing a modification in their resource profiles and/or timings), or if the underlying hardware should change, or (worst of all!) if the stack should be compelled to share those underlying resources (including memory), with another stack altogether (the multimode problem), then it is a virtual certainty that a ground-up redesign will be called for. Silo development is the embedded systems equivalent of spaghetti programming (where the hardwiring is across the dimension of resource allocation, rather than specifically program flow), and with the advent of complex, packet based multimode problems, it has reached the end of its useful life.

1.1 CVM Makes HRFs into Engines

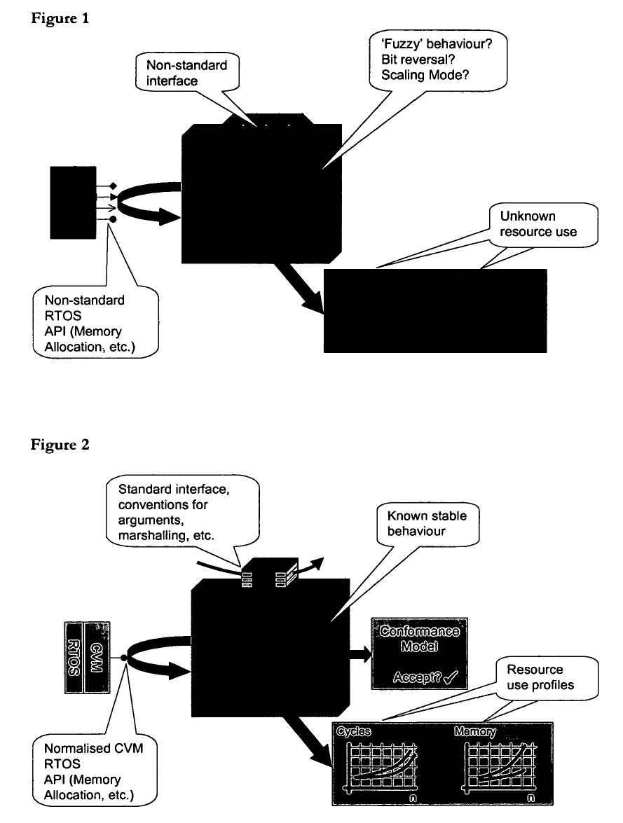

The first step away from silo development that CVM takes is in the area of HRFs (high-resource functions). In a typical wireless communications stack, nearly 90% of the overall system resources are consumed in such functions. However, in systems developed without CVM, HRFs (such as an FFT, for example), tend to be quite variable across different implementations. This is illustrated in FIG. 1.

The drawbacks here are:
Non-standard inbound API—calls to different vendors' FFT libraries are likely to utilise different argument lists, potentially even with different marshalling. This does not tend to promote interoperability.
Non-standard outbound API—different vendors' FFTs will probably require different services from the underlying RTOS, including memory allocation etc. Again, this tends to lower the extent to which they can be treated as commodities.
‘Fuzzy’ behaviour—everyone is pretty clear what a 16-bit IQ FFT should do, but there is still scope for considerable differences between implementation. For example, is bit reversal implemented? What about scaleback? Etc. Such differences in behaviour pose real problems for system designers.
Finally (and this is the most important for the present invention), unknown resource requirements. What will be the implications of calling this vendor's FFT in terms of memory (scratch and persistent), cycles, power, etc.? How will these requirements change as the size of the input vector changes? Without such data, published in a standard manner, intelligent scheduling becomes next to impossible.

CVM engines are HRFs with certain aspects standardized. This is illustrated in FIG. 2, above.

In comparison with the HRF case just considered, the CVM engine has the following attributes:
A standardised inbound API—meaning that all implementations of the FFT (for a given arithmetic model polymorph) will be called in precisely the same manner, regardless of underlying implementation.
Standard outbound API. In fact, engines are stipulated to have run-to-completion semantics within their thread domain (meaning that they never have to lock memory explicitly), and the only RTOS calls they may make are for dynamic memory allocation. Even then, it is strongly preferred that all of an engine's memory requirements be published up-front in its resource profile (see below), in which case no outbound interfaces at all are required for the engine implementer, who merely has to extract the necessary vector pointers to the arguments (and to any allocated scratch and persistent buffers), before (typically) dropping straight into assembler.
Known behaviour—all CVM engine implementations must be conformance tested against a ‘gold standard’ behavioural model—a reference engine—under an appropriate specification of equivalence. RadioScape publishes a number of standard models (i.e reference engines) (including, as it happens, a polymorphic FFT); developers may publish their own if required.
Finally, known resource requirements. All engines must have their resource usage profiled against at least cycles and memory for a range of vector dimensions and this information published as part of the component metadata. The resource requirements for memory should cover (explicitly) any required scratch and persistent memory, together with their formal parameter argument lists. Having this information available makes possible relatively accurate traffic-level simulation, as well as more intelligent run-time scheduling policies.
   1.2 CVM Executives May Not Directly Call Engines

Of course, having these nicely standardised HRFs in the form of engines is only part of the solution. We have now isolated most of our system's expensive processing inside commoditized components (engines) with known behaviour, standard APIs and profiled resource usage.

Yet all this would be for naught, from a resource scheduling point of view, if we allowed engines to be called directly by the high level code. This is because direct calls would, more or less, determine the underlying execution sequence and also the threading model. The latter point is critical for an efficient implementation. Even worse, on our CVM model of an engine, the caller would be responsible for setting up the appropriate memory (of both the scratch and persistent varieties) for the underlying engine, thereby quickly landing us back with explicit resource scheduling.

The CVM therefore takes the approach that engines must be called only via a middleware service —the scheduler. The scheduler effectively exists as a single instance across all executive process and logical threads, and decides, utilising a plug-in scheduling policy, which of these are to be submitted for execution to the underlying RTOS, using how many RTOS threads, at what priority, at each logical timestep. This is shown conceptually in FIG. 3.

1.3 CVM Tools and Design Flow

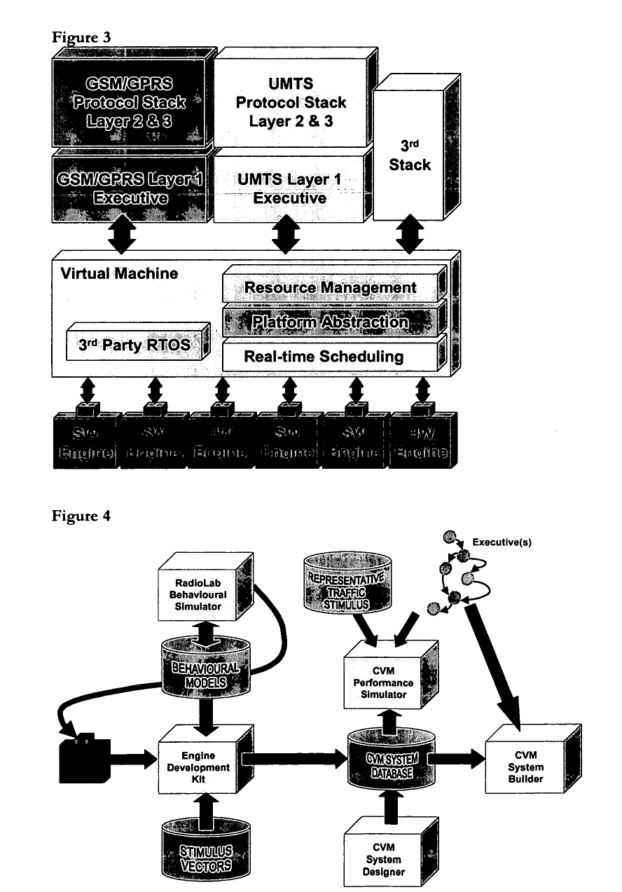

The overall design flow for the CVM is shown in FIG. 4. The RadioLab tool, using the polymorphic ‘gold standard’ reference versions of the various engines, is utilised to determine questions like the optimal bit widths for filters, likely performance of equalisers, etc. Then, a basic, high-level executive, not correct in all the details but with the vast majority of the necessary (and dimensioned, using the previous step) engine calls in place will be constructed, together with some representative traffic stimuli, and a candidate hardware platform will be selected.

In an extreme bottom-up flow, DSP engineers would then use the engine development kit (EDK), integrated with the appropriate DSP development tool (e.g., Visual DSP++) to construct optimised engines for all of the required HRFs in the system. These would be conformance tested against the gold standards and then performance profiled using the EDK.

For an extreme top-down flow, the same DSP engineers would simply publish their expected ‘forward declared’ performance profiles for the necessary engines, but would not actually write them. Reality is likely to lie somewhere between these two extremes, with the majority of needed engines either existing in engine form or requiring simply to be ‘wrapped’ and profiled, and with a few engines that do not yet exist (or have not yet been optimised) being forward declared.

Next, the designer would use the system designer to choose and deploy the appropriate number of instances of engine implementations against each required HRF from the executive. Then, a scheduling policy would be chosen using the system designer, and a traffic simulation executed. The results of this simulation would be checked against design constraints—and any mismatches would require either recoding of the ‘bottleneck’ engines, redesign with lowered functionality, or a shift in hardware platform or scheduler (and possibly a number of these).

Once a satisfactory result has been obtained (and multiple concurrent executives may be simulated in this manner), the executive developers can start to flesh out in more detail all of the necessary code inside the stack. As the executive is refined, traffic simulations should be continued to ensure that no surprising behaviour has been introduced (particularly where ‘forward declared’ engines have been used).

Finally, once all necessary engine implementations have been provided and the executive fully elaborated, an end deployment may be generated through the CVM system builder, which generates the appropriate runtime and also generates the makefiles to build the final system images.

3. Planes

As noted above, when designing a CVM system, the first step is to analyse the data flow, and on the basis of this, to partition the system into the set of planes. The set of planes, and the messages by which they communicate, is known as a framework.

A framework is a set of single-threaded elements that communicate by asynchronous message passing. These elements are called planes.

Each plane is represented in a framework by a blueprint. A blueprint is analogous to a factory in object-oriented programming. It determines how many instances of a plane are instantiated when the CVM system first starts up, and how many may be instantiated when it is running.

In order that the design can be broken down into modular layers, each plane can be sub-divided into a number of these elements:
modules
engines
drivers

In more specific terms, each plane may contain a single module, which in turn can contain any number of sub-modules, engines and drivers.

Modules provide the link between the asynchronous message-passing activity of planes and the synchronous high-resource processing activity of engines. Engines are encapsulations of intensive data processing functions that are typically targeted for a specific platform.

Both modules and engines have an accompanying procedural programming API which enables you to write the code for the two main methods within each module or engine:
a Configure method, to set up the initial state
a Process method, to perform data processing

The other type of element that can form part of a module is the driver. A driver enables a plane to interact with the hardware on which it is deployed. So, any sources, sinks or hardware engines in your system are likely to require a driver so that the controlling plane can communicate with them.

Enabling planes to communicate with each other are messages. CVM's in-built scheduler decides when to execute those planes that have messages waiting to be processed. Within a plane, only one thread can be in execution.

Planes are analogous to channels in many signal-processing systems. Planes send and receive messages, which they process asynchronously.

The CVM methodology encourages the user to break up a framework into planes using framing boundaries, timing boundaries and instantiation boundaries. Within these three types of boundary, planes are described at the interface level with both control and data processing behaviour.

Planes are instantiated by blueprints, which are the elements that are directly represented in the framework. Blueprints are analogous to factories in object-orientated programming, producing instances of planes and also dispatching and forwarding messages to and from the plane instances that they create. Blueprints detail the initial and maximum number of instances of the planes to be instantiated, but do not have XML files, instead being defined as part of the framework XML file.

You initially define a plane in two XML files which you create on the System Designer IDE. These files are:
A plane interface XML file
A plane XML file

The plane interface XML file defines the external properties of a plane, in terms of the type of messages that are input and output, while the plane XML file (sometimes known as the plane implementation file) identifies the top-level module within the plane and deals with memory requirements for any of its data or message processing.

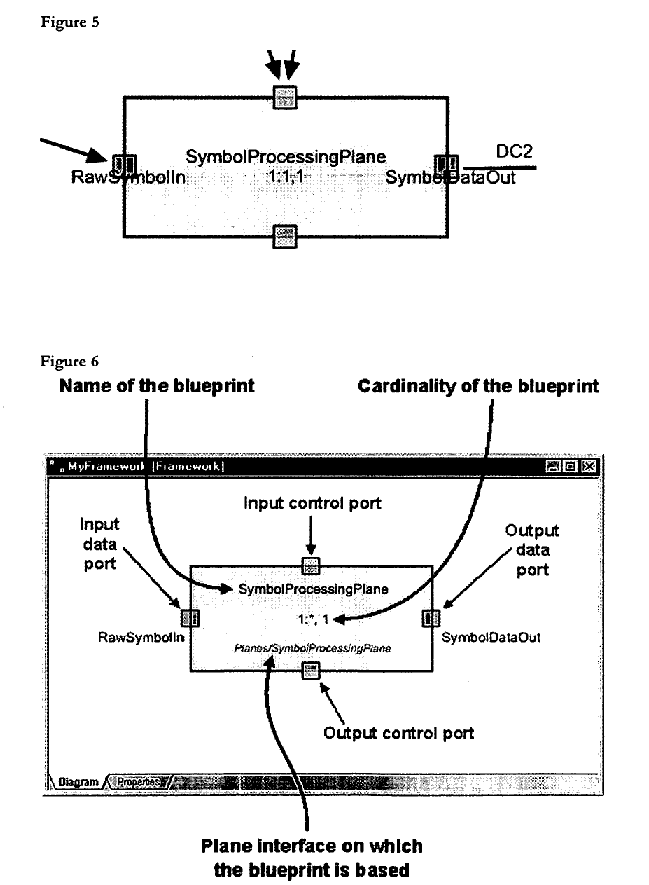

The role of the plane interface is illustrated in FIG. 5. Control messages enter at the top port of the plane and leave at the bottom port, and typed data messages enter at the left data port and leave at the right data port.

Data messages deal with data processing. In the example, there is an incoming data port and an outgoing data port, however, separate incoming and outgoing data ports must be defined for each type of incoming or outgoing data message that the plane will process. Therefore a plane might have many data ports.

Control messages deal with the configuration and control of data processing. They are not typed and all enter from one control port, and leave from another control port.

After initial design, when the CVM framework is ready to be deployed on a specific platform, a third XML file is used to deploy the plane correctly:
The plane deployment XML file

This file identifies the top-level module contained in the plane.

From these XL definition files, a number of C++ and C++ header files are automatically generated. These are:
The plane implementation C++ file and C++ header file
The plane co-class
The plane interface header file

These files are described below.

Plane Implementation C++ File and C++ Header File

Stub C++ and C++ header files for the implementation are automatically generated from the plane and plane interface XML files. You will add your own code to these files, to create the plane implementation.

The purpose of a plane implementation is to be responsible for message processing. It also to enable you to encapsulate a path of data processing, by means of the enclosed top-level module, which can invoke contained sub-modules and engines through their interfaces. Each plane implementation must provide C++ code for any transformations it does directly on the control and data messages it receives. Since planes are written in C++, the Process and Configure methods within a module can use all the normal C++ programming operations, including branching.

Plane Co-Class

The plane co-class file is automatically generated from the plane deployment XML file. It forwards incoming control messages directly to subscribing modules, and dispatches control messages from modules. It-may also perform memory management tasks.

Plane Interface Header File

The plane interface header file is automatically generated from the plane interface XML file and references and invokes the plane implementation.

4. Blueprints

Blueprints are the elements from which instances of planes are created, where each instance from a single blueprint is the same.

Most often a blueprint creates a single plane, but in those cases where you need two or more identical plane instances, a blueprint is the means of providing these instances. You can think of a blueprint as a static template for a plane. The blueprint contains information about plane cardinality that is not contained in the plane interface. It will also dispatch and forward messages to and from the plane instances that it creates.

Unlike the other elements in CVM, blueprints do not have an associated XML file. This is because a blueprint is generated when you specify that you want a new blueprint based on an existing plane interface included in the XML file for a framework.

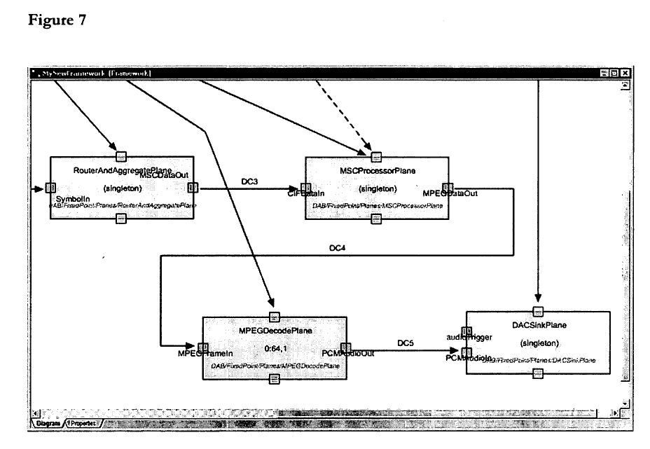

Although you can create a blueprint in a framework on the XML editor of the System Designer, it is simpler to do so on the diagram editor. This allows you to select the plane interface to base the blueprint on. Once you've made your choice, the blueprint appears in the window, containing default details, as shown in the FIG. 6 example.

The editable name of the blueprint is displayed at the top of the blueprint box, and the read-only pathname of the plane interface on which the blueprint is based is displayed at the bottom. Sandwiched in between is the cardinality of the blueprint, that is, the number of planes it creates initially and the maximum and minimum number it can maintain during the execution of the system. The default is for a single plane instance to be created, and this is indicated like so:
1:*, 1

The first number here is the minimum number of planes to be instantiated (1), the second number is the maximum number of planes to be instantiated (* means no limit), and the third number is the number of planes to be instantiated on startup (1).

5. Framework

At the top of the hierarchy of CVM elements is the framework. Any communications system you choose to implement in CVM must have a single framework which contains all the planes, modules, engines, drivers and so on that deal with the various facets of that system's functionality.

Once you have analysed the data flow requirements of the system you require, your system architect can begin the process of partitioning a framework for the system.

At the top level of partitioning, a framework consists of blueprints. As described in the previous section, blueprints can be thought of as templates for planes, enabling you to create more than one instance of the same plane.

Blueprints are linked together in a framework with various types of connection that represent the routes of asynchronous messages between planes in the deployed system.

For simple systems there will be a one-to-one correspondence between blueprints and planes, as each blueprint will instantiate exactly one plane. Blueprints can, however, instantiate multiple planes and when they do, they also route incoming/outgoing messages to/from their children.

So, in the FIG. 7 example framework, while most of the blueprints (represented by blue rectangles) are singletons and instantiate only a single plane, the MPEG decoder blueprint is dynamic which means that it can instantiate multiple MPEG decoder planes.

5.1 Framework Development

The top-down view of a communications system is provided in CVM through a framework. Within a framework, the engineers must identify blueprints and must connect the ports on these blueprints together. Each blueprint is to be associated with a plane, the association being identified by a plane interface. Along each of the connections, implementations of these planes are set up to send and receive messages.

The CVM System Designer IDE automatically generates infrastructure code from this framework design.

Planes have been developed within the CVM design flow to model DSP ‘processing channels’. They also handle multiplexing and de-multiplexing tasks and represent sources and sinks. In these ways, the use of planes can greatly simplify the job of building complex communications systems, such as the DAB receiver in this case study.

You can identify candidate blueprint boundaries within a framework using a set of simple rules. By following these rules you can follow a natural path of development from system-level design through to code.

5.2 How do you Describe a Framework?

You define frameworks in XML using the diagram editor of the CVM System Designer. The framework XML description you create contains details of the blueprints that comprise the framework and the connections between them. These blueprints reference plane interfaces, which in turn have their own XML descriptions.

The framework XML file captures all of the connections between blueprints from the details given on the diagram editor. The system architect could define a framework simply by making entries in the XML file on the XML editor of the System Designer, but will generally find it easier to use the diagram editor.

At system build time the engineer can create a deployment from a framework. Part of this involves fully specify implementations for all the interfaces within the framework. The first stage in specifying an implementation is to select the plane interface on which the implementation is to be based.

Once you have a deployment you can automatically generate C++ infrastructure code on the System Designer. This code includes boot and initialisation code for the CVM system you have created, which you can then compile for the target hardware.

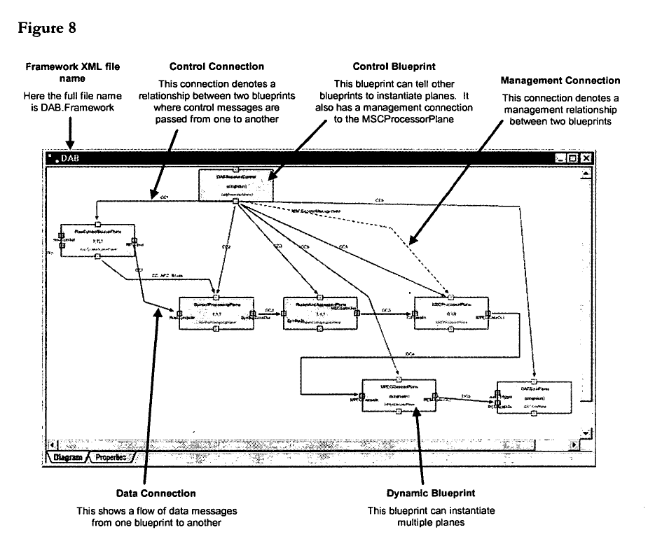

Within the CVM System Designer, both an XML editor and a diagram editor are provided for creating a framework and managing the XML definitions for your CVM elements. Examples of both these editors are shown in FIG. 8, starting with a framework shown in the diagram editor.

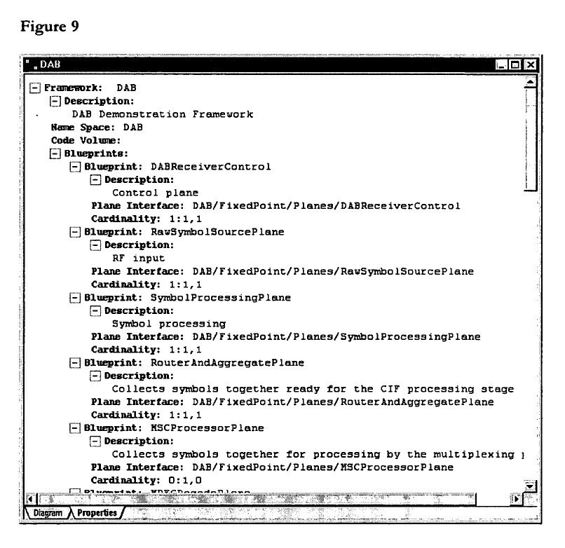

The XML captured from the above framework diagram looks like FIG. 9 when viewed with the XML editor of the System Designer. The actual XML file generated by the above definition looks like this:

```
<?xml version=“1.0” ?>
- <Framework Name=“DAB” Description=“DAB Demonstration Framework”
    Namespace=“DAB”>
  - <Blueprints>
      <Blueprint Name=“DACSinkPlane” Description=“Decodes audio from
        MPEG to PCM” Cardinality=“1:1!,1”
        PlaneInterface=“DAB/FixedPoint/Planes/DACSinkPlane” />
      <Blueprint Name=“MPEGDecodePlane” Description=“Decodes audio from
        MPEG to PCM” Cardinality=“0:64,1”
        PlaneInterface=“DAB/FixedPoint/Planes/MPEGDecodePlane” />
      <Blueprint Name=“MSCProcessorPlane” Description=“Collects symbols
        together for processing by the multiplexing planes” Cardinality=“0:1,0”
        PlaneInterface=“DAB/FixedPoint/Planes/MSCProcessorPlane” />
      <Blueprint Name=“RouterAndAggregatePlane” Description=“Collects
        symbols together ready for the CIF processing stage” Cardinality=“1:1,1”
        PlaneInterface=“DAB/FixedPoint/Planes/RouterAndAggregatePlane” />
        <Blueprint Name=“SymbolProcessingPlane” Description=“Symbol
        processing” Cardinality=“1:1,1”
        PlaneInterface=“DAB/FixedPoint/Planes/SymbolProcessingPlane” />
    <Blueprint Name=“RawSymbolSourcePlane” Description=“RF input”
        Cardinality=“1:1!,1”
        PlaneInterface=“DAB/FixedPoint/Planes/RawSymbolSourcePlane” />
      <Blueprint Name=“DABReceiverControl” Description=“Control plane”
        Cardinality=“1:1!,1”
        PlaneInterface=“DAB/FixedPoint/Planes/DABReceiverControl” />
  </Blueprints>
- <DataConnections>
    <DataConnection Name=“DC5” Description=“PCM Data ready for play out”
        FromBlueprint=“MPEGDecodePlane” FromPort=“PCMAudioOut”
        ToBlueprint=“DACSinkPlane” ToPort=“PCMAudioIn” />
    <DataConnection Name=“DC4” Description=“An MPEG frame ready for
        decoding” FromBlueprint=“MSCProcessorPlane”
        FromPort=“MPEGDataOut” ToBlueprint=“MPEGDecodePlane”
        ToPort=“MPEGFrameIn” />
    <DataConnection Name=“DC3” Description=“A CIF's worth of data to
        decode” FromBlueprint=“RouterAndAggregatePlane”
        FromPort=“MSCDataOut” ToBlueprint=“MSCProcessorPlane”
        ToPort=“CIFDataIn” />
    <DataConnection Name=“DC2” Description=“Processed data from the
        symbol processing to the multiplexing point”
        FromBlueprint=“SymbolProcessingPlane” FromPort=“SymbolDataOut”
        ToBlueprint=“RouterAndAggregatePlane” ToPort=“SymbolIn” />
    <DataConnection Name=“DC1” Description=“Data from the RF source to
        the symbol processing” FromBlueprint=“RawSymbolSourcePlane”
        FromPort=“RFoutput” ToBlueprint=“SymbolProcessingPlane”
        ToPort=“RawSymbolIn” />
  </DataConnections>
- <ControlConnections>
        <ControlConnection Name=“CC_AFC_Route” Description=“Allows
        frequency error to be sent” FromBlueprint=“RawSymbolSourcePlane”
        ToBlueprint=“SymbolProcessingPlane” />
    <ControlConnection Name=“CC6” Description=“Controls the sink”
        FromBlueprint=“DABReceiverControl” ToBlueprint=“DACSinkPlane”
        />
      <ControlConnection Name=“CC5” Description=“Controls the MPEG
        Decoder” FromBlueprint=“DABReceiverControl”
        ToBlueprint=“MPEGDecodePlane” />
```

### EXAMPLE 1

### Framework XML Code Generated by XML Editor

The framework XML file will eventually be mapped to a specific deployment, and used to automatically generate C++ code.

5.3 How to Develop a Framework

In order to be able to identify plane boundaries in a CVM system that you want to construct, you must first study the data flow within the proposed system. To analyse this data flow you might do the following:
Read documents about the data flow (such as the EN 300 401 specification document for DAB).
Develop mathematical models for the data flow.
Inspect existing software implementations.

From this flow, you then do the following:
1. Partition the framework into blueprints.
2. Identify the cardinality of each blueprint, that is, the number of planes each blueprint instantiates.
3. Connect these blueprints together using data, control and management connections.

Each of these steps is described below.

5.4 Partition the Framework

You partition the framework into blueprints according to two domains:
thread domains
time domains

A thread domain is a cluster of RTOS threads, each of which may assume a priority level within a pre-defined range, and which is available for allocation by a single thread scheduler to a number of plane instances.

It is not necessary at this initial stage in development to identify every aspect of the data flow. But there are a number of positions within the flow that will be of particular interest when it comes to identifying planes. These are:
where connections with external devices occur
where changes in framing or timing boundaries occur
where dynamic instantiation or dynamic routing occurs

Each of these types of place within the data flow is significant because each represents a location where “normal” sequential programming is not sufficient to capture the required behaviour. At each of these locations something more than straightforward imperative coding is needed, because there is some form of buffering, rate matching, routing, multiplexing or de-multiplexing required.

For each area bounded by each of these features you must assign a blueprint within the framework.

At the same time as assigning blueprints, you will also be mapping the flow of data from one blueprint to another, by means of data connections between blueprints.

5.5 Identify Blueprint Cardinalities

Having identified the blueprints the engineer now needs to further evaluate the cardinality of each blueprint—that is, the number of planes it creates initially and the maximum and minimum number it can maintain concurrently during the execution of the system.

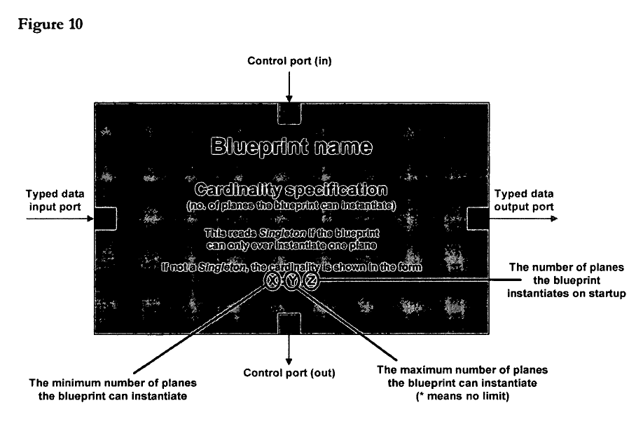

The way in which cardinality is specified on a blueprint is illustrated in FIG. 10.

While identifying blueprint cardinalities, any requirements for management connections will also become apparent. Management connections are required for dynamic blueprints, as explained below.

There are three types of cardinality:
singleton
singular
dynamic

Each of these is described below.

5.6 Singleton Cardinality

A singleton blueprint contains one and only one plane, which is created at boot time and persists for the duration of the system's execution.

A blueprint must be a singleton if the plane interface contained within it needs to manage dynamic blueprints or if it needs access to an interrupt. It is the only instance of its class. Singleton blueprints are forced to have initial, minimum and maximum cardinality of 1. A singleton is shown in the XML editor as having cardinality “1:1,1”, while on the diagram editor it is labelled as (singleton).

This type of blueprint is frequently seen for:
“central” control blueprints (because control blueprints manage the creation of planes).
“data flow boundary” planes (because these type of blueprints typically need to interact with IO routines which require the handling of interrupts).
   5.7 Singular Cardinality

A singular blueprint is one that just happens to generate only one instance of a plane within a framework, rather than being inherently restricted in the number of planes it can instantiate.

Like singletons, singular blueprints have initial and maximum cardinality of 1. This is shown in the XML and in the editor as “1:1,1”. However, these cardinalities are the result of application reasons rather than because of interrupt or management connectivity.

This type of blueprint is frequently seen in two circumstances:
near to “data flow boundaries”, where initial filtering and shaping, and modulation and demodulation occurs near to system input or output devices
where multiplexing, de-multiplexing and routing occurs.
   5.8 Dynamic Cardinality

Dynamic blueprints occur when there is a need for a variable number of planes all doing the same type of work. Dynamic blueprints always have zero planes initially. The maximum number of planes that may simultaneously exist may be left open, as indicated by the asterisk in the cardinality “0:*,0”, or may be set to an upper limit, such as “0:64,0”, where 64 is the maximum number of planes that can be instantiated from the blueprint.

In addition to data and control message connections, dynamic blueprints must also always have a single management connection. A management connection is the ability for one plane to create another plane. This type of connection allows the manager to create new instances of planes within the dynamic blueprint. This connection type is shown as a dotted line in the editor.

Dynamic blueprints are frequently seen where support for multiple channel encoding or decoding is needed. Typically, the standard or the product specification will determine the maximum cardinality in this situation.

5.9 Identify Blueprint Connectivity

From the data path analysis and from the cardinality analysis, you should now have identified all the blueprints, all the data path connections and all the management path connections you need.

The only remaining connections to identify are control connections for control messages. To identify these control messages, attend to each blueprint in turn and concentrate only on the input control messages that each blueprint is to expect.

In considering these control message inputs, there are two distinct types of control message:
Shared memory messages
Configuration messages

These are described in turn below.

5.10 Shared Memory Messages

From the data flow analysis, you may notice there are some “parameterisation values” that are required to be shared between planes. In traditional embedded engineering these values are often shared using global variables. In the CVM design flow, however, they are communicated using shared memory messages.

The use of shared memory messages has the advantage that the code produced is more re-usable and portable, and moreover has the added benefit that, since messages are time-stamped, the recipient can transfer and correctly use a sequence of values (a sequence of messages) without requiring complicated manually-engineered synchronisation code.

This data flow analysis will typically reveal the source of these messages as being other existing blueprints within the framework. In the case of shared memory messages, you simply connect the output control port of the source blueprint with the input control port of the destination blueprint.

You might find on occasions that it is not obvious where these control messages should originate. In this situation, it is likely that the message should actually come from stack protocol control code. If this is the case, you will need to add one or more additional blueprints to represent the protocol stack.

5.11 Configuration Messages

When you analyse the data flow you may notice certain parameters that are required for initial system configuration, or that might be needed if the system is dynamically reconfigured, such as when an operating mode or channel data rate changes.

These configuration messages will typically be sent from protocol stack control code which will itself be receiving configuration signals and requests over the communications protocol and perhaps also from user interface and other local control code.

When considering these messages it is quite common to discover that none of the existing blueprints within the framework seem to be quite the right source for these messages. If this is the case, then it is likely that these messages should come form some stack protocol control code. So you will need to add one or more blueprints to the framework specifically for this protocol stack control activity.

If you follow the simple guidelines set out above, you will find that your framework is separated into a minimal number of component parts. Subsequently you can choose to sub-divide blueprints to make them more re-usable, but it is more important to divide up the basic requirements for the data processing path from the framework

6. Planes in More Detail

As noted earlier, planes are analogous to channels in signal-processing systems. Planes consume incoming data and control messages, and can also send data and control messages.

Data and control messages flow as asynchronous events, known as messages, between planes within a framework, and they do so under the ultimate control of a global scheduler.

Inside a plane, the data flow is imperative and single-threaded. The CVM scheduler ensures that each plane actively consumes no more than one message at any time. The scheduler provides the threads on which individual planes can process (or ‘pump’) their messages, extracting them from the message queue, unpacking their arguments, and then calling the appropriate handler methods on the code within the plane.

The asynchronous communications between planes are queued for consumption by each plane and are further ordered in each queue according to each message's timestamp. These timestamps are typically defined according to system-related frame or symbol identifiers. This ordering assists the system engineers in the co-ordination of time-sensitive events, such as the re-configuration of a data transport channel.

Further, CVM provides time domains that describe the relationships of these timestamps across different blueprints within a framework. The existence of these time domains assists the system engineer with tasks such as relating the timing of processing occurring at different framing levels within the flow (at the symbol and MPEG frame levels in the DAB case study) and rate matching within a system where independent asynchronous channels have to be synchronised using some technique.

6.1 CVM Built-in Data Types and PPOs

The CVM System Design Class Library (SDCL) provides support for platform independent data types for use within applications. These data types include:
A set of normalised primitive types P: including fixed bit width integers, unsigned integers and IEEE-compliant floating point numbers.
Support for Complex<P> for the primitive types described above.
Support for low-overhead arrays, Array<T>, where T is the set of core types defined as the union of P and all numerical Complex<P>s.
Support for specialisations of these arrays for scratch memory: when the underlying data type of an array is translated by an operation; when memory relocation may occur and so locking of the memory is important; or when memory ownership is transferred.

CVM core types, T, and arrays of core types can be transferred between planes in messages and can be passed to modules and engines as method arguments. There are seven main ‘modes’ in which you can pass these parameters. These modes are stipulated by the CVM parameter passing options (PPOs). The PPOs available to you are:
in
inout
out
infree
inshared
outalloc

These PPOs do not exist directly in user code, but rather in the XML description files that define the interfaces of planes, modules, engines and messages. They are then translated to type-safe and ownership-safe C++ implementations.

6.2 How do you Describe a Plane?

To write a plane you do the following:
Describe its interface in a plane interface XML file.
Describe its implementation in a plane XML file.
Write code in an automatically generated C++ file.

You must write an XML description for each plane interface. This XML defines the data input and output ports of the plane interface and the types of messages through those ports.

You must also write an XML description for each plane implementation. In keeping with all interface/implementation relationships, there may be several implementations for a single plane interface, all with different implementation-specific properties.

Each plane implementation has the following facets:
It contains information on the memory used for the implementation.
It may declare a module that the plane will use for its data processing.
To provide encapsulation and flexibility in the system architecture, the plane will declare this module by referencing a module interface XML file.
It provides links to the C++ code files discussed below.

The C++ code files provide the actual instructions that will be driven by the data and control messages at this plane level. This message handling code will, of course, need to be written by engineers developing the plane. They can do this using their normal C++ IDE. To assist them the System Designer IDE also provide functionality to automatically generate code for the infrastructure function within the plane. An example of such code is the method prototypes that send and receive these plane level messages.

Additionally, the System Design Class Library (SDCL) contains a plane base class that provides common plane functionality. This functionality includes the methods for accessing the plane ports and for querying the timestamps of messages seen by the plane.

At deployment time, the system architect deploys plane implementations to realise the plane interfaces within each of the blueprints of a framework. (These plane implementations will have been developed by the System Engineers.) To deploy the plane you also have to resolve any interfaces declared by the plane. So, if the plane does declare a module within it, then the user must choose a module implementation to match that interface. Using this deployment information, which again is described in an XML file, the System Designer IDE can generate further infrastructure C++ files for the deployed system, including a co-class for the plane implementation. This feature of fully automatically generated co-classes is also used at module and engine level.

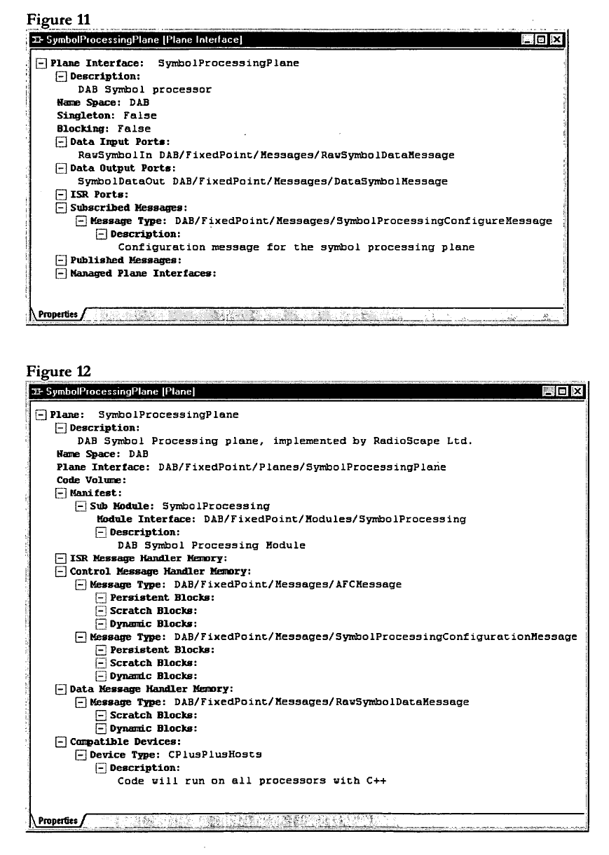

These co-classes are critical to the success of CVM in enabling system architects to experiment with the parameters of the developed systems without changing the application code. These plane Co-classes and their functionality are described more fully in the ‘Executive Developers Guide’. The plane interface for a DAB case study (not included in this specification) is shown in FIG. 11, as it would look in the System Designer editor. The XML file generated by the System Designer editor for the plane interface definition shown above would look like this:

```
<?xml version=“1.0” ?>
- <PlaneInterface Name=“SymbolProcessingPlane”
    Namespace=“DAB”
    Description=“DAB Symbol processor”
    Singleton=“False” Blocking=“False”>
  - <DataInputPorts>
      <DataInputPort Name=“RawSymbolIn” Description=“Raw DAB
        Input samples”
MessageType=“DAB/FixedPoint/Planes/RawSymbolDataMessage” />
  </DataInputPorts>
  - <DataOutputPorts>
    <DataOutputPort Name=“SymbolDataOut” Description=“CIF Data
      (portions of symbols)”
      MessageType=“DAB/FixedPoint/Planes/DataSymbolMessage”
      />
  </DataOutputPorts>
  <ISRPorts />
  - <SubscribedMessages>
  - <!-- Note this plane does not subscribe to AFC messages - but its sub
    modules probably do -->
  - <!-- <MessageHandler
    MessageType=“DAB/FixedPoint/Planes/AFCMessage”
    Description=“Update frequency error.” OverflowMode=“Modulo”
    ScalingMode=“NoScale” RoundingMode=“Fix”/> -->
                                        <MessageHandler
      MessageType=“DAB/FixedPoint/Planes/
      SymbolProcessingConfigure
      Message” Description=“Configuration message for the symbol
      processing plane” OverflowMode=“Modulo”
      ScalingMode=“NoScale” RoundingMode=“Fix” />
  </SubscribedMessages>
  <PublishedMessages />
  <ManagedPlanes />
</PlaneInterface>
```

### EXAMPLE 2

### XML for the Plane Interface

A possible implementation of this plane interface is shown in FIG. 12, as it would appear in the System Designer editor.

The XML file automatically generated from this definition by the System Designer looks like this:

```
<?xml version=“1.0”?>
- <Plane Name=“SymbolProcessingPlane” Description=“DAB Symbol
    Processing plane, implemented by RadioScape Ltd.”
    PlaneInterface=“DAB/FixedPoint/Planes/SymbolProcessingPlane”
    Namespace=“DAB” CodeVolume=“”>
  - <Manifest>
      <SubEngines />
    - <SubModules>
        <SubModule Name=“SymbolProcessing” Description=“DAB
          Symbol Processing Module”
          ModuleInterface=“DAB/FixedPoint/Modules/SymbolProcessing”
          />
      </SubModules>
    </Manifest>
  - <!-- ISR message handler memories go here, but only for singletons -->
    <ISRMessageHandlerMemories />
  - <ControlMessageHandlerMemories>
    - <ControlMessageHandlerMemory
        MessageType=“DAB/FixedPoint/Planes/AFCMessage”>
        <PersistentBlocks />
        <DynamicBlocks />
        <ScratchBlocks />
      </ControlMessageHandlerMemory>
  - <ControlMessageHandlerMemory
        MessageType=“DAB/FixedPoint/Planes/SymbolProcessingConfigurationMessage”>
        <PersistentBlocks />
        <DynamicBlocks />
          <ScratchBlocks />
      </ControlMessageHandlerMemory>
    </ControlMessageHandlerMemories>
  - <DataMessageHandlerMemories>
- <DataMessageHandlerMemory
      MessageType=“DAB/FixedPoint/Planes/RawSymbolDataMessage”>
      <PersistentBlocks />
      <DynamicBlocks />
      <ScratchBlocks />
    </DataMessageHandlerMemory>
  </DataMessageHandlerMemories>
- <CompatibleDevices>
          <CompatibleDevice DeviceType=“CPlusPlusHosts”
      Description=“Code will run on all processors with C++” />
  </CompatibleDevices>
</Plane>
```

### EXAMPLE 3

### XML for the Plane

The System Designer IDE can process this XML of Example 3 above to generate partial C++ code, as shown below:

```
// Parts of this file are automatically generated//
// Generated by the CVM
//
// PlaneHandler header for plane: SymbolProcessingPlane
//
// DAB Symbol Processing plane, implemented by RadioScape Ltd.
#ifndef SYMBOLPROCESSINGPLANE_PLANE_H
#define SYMBOLPROCESSINGPLANE_PLANE_H
  #include <Runtime/CVMPlaneDefs.h>
#include “Messages.h”
// user includes here
// AUTO_REGEN_START-plane-header
#include “SymbolProcessingInterface.h”
namespace DAB
{
class SymbolProcessingPlane
{
public:
  SymbolProcessingPlane( );
  ˜SymbolProcessingPlane( );
  void SetPlane(CVM::PlaneBase& plane) { m_plane = &plane ;}
  void SetModule(DAB::SymbolProcessingInterface& module)
{ m_module = &module ;}
  CVM::Result OnMessage(RawSymbolDataMessage &message);
  CVM::Result OnMessage(SymbolProcessingConfigureMessage
  &message);
private:
  CVM::PlaneBase *m_plane;
  DAB::SymbolProcessingInterface *m_module;
// AUTO_REGEN_END-plane-header
// Your Code
public:
// user class members here
private:
};
// AUTO_REGEN_START-plane-footer
} // namespace DAB
#endif // SYMBOLPROCESSINGPLANE_PLANE_H
// AUTO_REGEN_END-plane-footer
```

### EXAMPLE 4

### Partial C++ Code Generated from the Plane XML

The generated stub code shown above incorporates the following items:
Constructor
Destructor
OnMessage( ) handlers for each message—class namely the DataMessage and ConfigureMessage.

The generated C++ code for a plane contains specially marked sections such as this one:

```
// CODEGEN_INSERTION_POINT-messages
// AUTO_REGEN_START-message-decl-ISRMessage
CVM::Result RawSymbolSourcePlane::OnMessage(ISRMessage
&message)
// AUTO_REGEN_END-message-decl-ISRMessage
{
  return CVM::S_NOERROR;
}
// AUTO_REGEN_START-message-decl-
SymbolSourceSubscriptionMessage
CVM::Result
RawSymbolSourcePlane::OnMessage(SymbolSourceSubscriptionMessage
&message)
// AUTO_REGEN_END-message-decl-
SymbolSourceSubscriptionMessage
{
  return CVM::S_NOERROR;
}
```

These AUTO_REGEN_START\AUTO_REGEN_END tags allow the code generation to be repeated after any changes have been made to the plane or plane interface XML files.

You should NOT edit any code within these
AUTO_REGEN_START\AUTO_REGEN_END areas of the code.
   You are, though, free to edit all other code in the file.

The automatically generated co-class code for the plane shown in 4, which shows an AFC message being sent directly to the appropriate module, is shown below:

```
  // The file is entirely AUTOMATICALLY GENERATED CODE - DO NOT EDIT
//
// Generated by the CVM
//
// Co-class for Plane: SymbolProcessingPlane
//
// DAB Symbol Processing plane, implemented by RadioScape Ltd.
#ifndef SymbolProcessingPlane_PLANE_CO-CLASS_H
#define SymbolProcessingPlane_PLANE_CO-CLASS_H
#include “Runtime/CVMPlaneDefs.h”
#include “Messages.h”
#include “SymbolProcessingPlane.h”
#include “SymbolProcessingCo-class.h”
namespace DAB
{
class SymbolProcessingPlaneCo-class : public CVM::PlaneBase
{
public:
  SymbolProcessingPlaneCo-class( )
  {
    m_plane.SetPlane(*this);
    m_plane.SetModule(m_module);
  }
public:
  CVM::Result DispatchMessage(CVM::Message &message)
  {
    CVM::Result result;
    switch(message.GetTypeId( ))
      {
      case DAB_{——}RawSymbolDataMessageId:
        result =
m_plane.OnMessage(static_cast<DAB::RawSymbolDataMessage&>(message));
        break;
      case DAB_{——}AFCMessageId:
        {
          const DAB::AFCMessage &m =
static_cast<DAB::AFCMessage&>(message);
          result =
m_module.m_MainSymbolProcessing.OnAFCMessage(m.m_frequencyError);
        }
        break;
      case DAB_{——}SymbolProcessingConfigureMessageId:
        result =
m_plane.OnMessage(static_cast<DAB::SymbolProcessingConfigureMessage&>(message));
        break;
      default:
        CVM_RT_LOG_ERROR(“SymbolProcessingPlane received an unexpected
message with type ID %d\n”, message.GetTypeId( ));
        result = CVM::E_FAILED;
        break;
    }
    return result;
  }
private:
  SymbolProcessingPlane m_plane;
  SymbolProcessingCo-class m_module;
};
  } // namespace DAB
#endif // SymbolProcessingPlane_PLANE_CO-CLASS_H.
```

### EXAMPLE 5

### Plane Co-Class Code

The SymbolProcessingPlane Co-class in the sample code above is derived from the plane base class. The constructor gives the plane a reference to the module interface. It also gives the plane a reference to itself

The switch statement is used to dispatch data and control messages:
Data messages are dispatched to the plane implementation.
Control messages are dispatched to the subscribed sub-module.
A configure message is also sent to the plane responsible for configuring the top-level module, which in turn configures all of its sub-modules.
   7. Module Development

The basic role of a module is to provide an encapsulation of a path of data processing, so that all the modules in a CVM system combine to give the logic of the data flow in the system you are creating.

Modules do not, though, perform that processing directly, since all tasks that require any significant amount of processing are handled by engines.

The data flow logic of a module is contained within its Process method. This method typically involves the execution of programming structures, such as sequential code, for loops and conditional branches, and also the invocation of the Process methods of sub-modules and engines contained within the module. In order to provide portability, re-usability and flexibility within the delivered end system, these sub-modules must be reference by module interfaces and likewise the component engines of the module must be referenced by engine interfaces.

To perform the role of provider of logic to the data flow, a module will frequently need to send and receive control messages. For instance, a module might need to send and receive updated sets of control values to and from other elements in the system. These control values offer management of the data processing path (not control in the sense of the state machines and other logic frequently found in the “control layer” of a communications stack). In order to send and receive these messages, the same ability to send and receive message payloads is exposed to modules. However, the message structures themselves, and especially the message headers containing the timing and message-sender information, are not exposed at the module level. Instead, for receiving messages the message payloads are exposed via C++ procedural APIs on the module itself, and for sending messages the message payloads are exposed via MessageSender objects.

The paragraph above highlights a key difference between planes and modules:
Planes exist in an event driven programming model. They send and receive messages as structures and they have access to the header information in those messages.

Modules exist in a procedural programming model. They are invoked on methods and they may call methods. They do not see messages or the header information attached to them.

7.1 How do you Describe a Module?

To write a module, you do the following:
Describe its interface in a module interface XML file.
Describe its implementation in a module XML file.
Write code in an automatically generated C++ file.

An XML description exists for each module interface. This XML defines the Process and Configure signatures of the module interface and the types of message this module interface can send and receive.

An XML description exists for each module implementation. As with all the interface/implementation relationships, there may be several implementations for a single module interface, each with different implementation-specific properties. Each module implementation:
Contains information on the memory used for the implementation.
May declare sub-modules that the module will use for its data processing. To provide encapsulation and flexibility in the system architecture, the module will declare these sub-modules by referencing module interface files.
May declare engines that the module will use for its data processing. To provide encapsulation and flexibility in the system architecture, the module will declare these engines by referencing engine interface files.

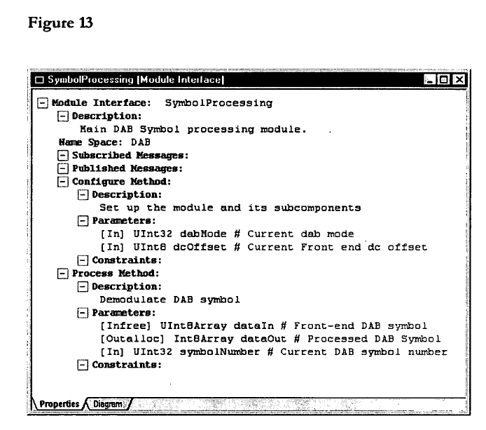

The module interface for the DAB case study is shown in FIG. 13, as it would look in the System Designer editor.

The XML file generated by the System Designer editor for the module interface definition shown above would look like this:

```
  <?xml version=“1.0” ?>
- <ModuleInterface Name=“SymbolProcessing”
Description=“Main DAB
      Symbol processing module.” Namespace=“DAB”
      Blocking=“False”>
    <SubscribedMessages />
    <PublishedMessages />
  - <ConfigureParameters Description=“Set up the module and its
        subcomponents”>
        <ParameterType Name=“dabMode” Description=“Current dab
          mode” DataType=“UInt32” ParameterPassingOption=“In” />
      <ParameterType Name=“dcOffset” Description=“Current
          Front end dc offset” DataType=“UInt8”
          ParameterPassingOption=“In” />
    </ConfigureParameters>
  - <ProcessParameters Description=“Demodulate DAB symbol”
        ScalingMode=“AutoScale” OverflowMode=“Modulo”
        RoundingMode=“Fix”>
        <ParameterType Name=“dataIn” Description=“Front-end DAB
          symbol” DataType=“UInt8Array”
          ParameterPassingOption=“Infree” />
        <ParameterType Name=“dataOut” Description=“Processed DAB
          Symbol” DataType=“Int8Array”
          ParameterPassingOption=“Outalloc” />
        <ParameterType Name=“symbolNumber” Description=“Current
          DAB symbol number” DataType=“UInt32”
          ParameterPassingOption=“In” />
    </ProcessParameters>
    <ConfigureConstraints />
    <ProcessConstraints />
</ModuleInterface>
```

### EXAMPLE 6

### XML for the Module Interface

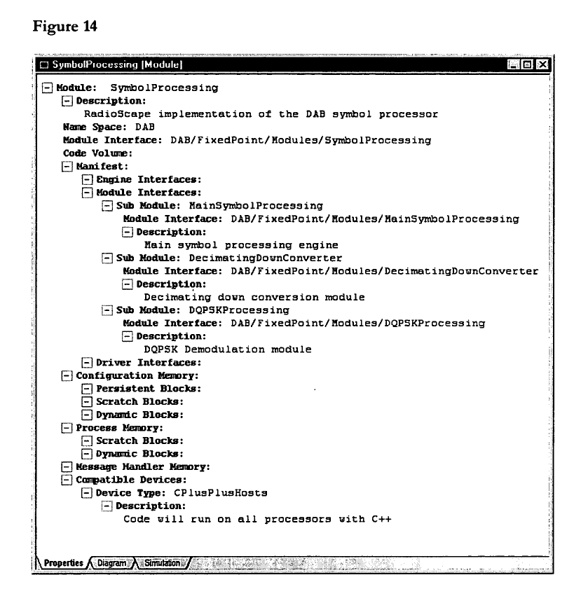

A possible implementation of this module interface is shown in FIG. 14, as it would appear in the system designer editor.

The XML file generated from this definition by the System Designer module editor looks like this:

```
<?xml version=“1.0” ?>
- <Module Name=“SymbolProcessing”
    ModuleInterface=“DAB/FixedPoint/Modules/SymbolProcessing”
    Description=“RadioScape implementation of the DAB
    symbol processor”
    Namespace=“DAB”>
  - <Manifest>
      <SubEngines />
    - <SubModules>
              <SubModule Name=“MainSymbolProcessing”
          ModuleInterface=“DAB/FixedPoint/Modules/MainSymbol
          Processing” Desctiption=“Main symbol processing engine”
          />
            <SubModule Name=“DecimatingDownConverter”
          ModuleInterface=“DAB/FixedPoint/Modules/DecimatingD
          ownConverter” Description=“Decimating down conversion
          module” />
              <SubModule Name=“DQPSKProcessing”
          ModuleInterface=“DAB/FixedPoint/Modules/
          DQPSKProcessing”
          Description=“DQPSK Demodulation module” />
      </SubModules>
    </Manifest>
  - <ConfigureMemory>
      <PersistentBlocks />
      <ScratchBlocks />
      <DynamicBlocks />
  </ConfigureMemory>
  - <ProcessMemory>
      <ScratchBlocks />
      <DynamicBlocks />
    </ProcessMemory>
<MessageHandlerMemories />
- <CompatibleDevices>
          <CompatibleDevice DeviceType=“CPlusPlusHosts”
      Description=“Code will run on all processors with C++” />
  </CompatibleDevices>
</Module
```

### EXAMPLE 7

### XML for the Module

The C++ code files provide the actual instructions that will be driven by the Process method, Configure method and message handler invocations at this module level. These instructions will, of course, need to be written by engineers developing the module. They can do this using their normal C++ editors. To assist them the System Designer IDE also provides functionality to automatically generate code for the infrastructure code within the module, such as the method prototypes for these methods.

At deployment time, the system architect will deploy a module implementation to realise the module interfaces referenced within deployed planes and within other deployed modules. To deploy each module, the user will have to resolve any interfaces declared by the module. So, if a module declares sub-modules and engines within it, then the user must choose a module and engine implementations to match each interface.

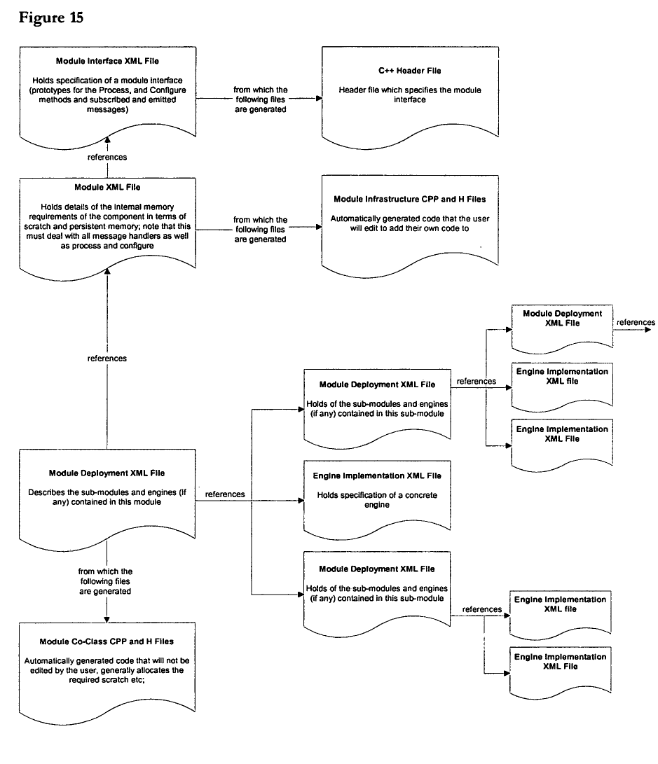

The relationship between the module interface, module and module deployment files is shown in FIG. 15. In this illustration, some of the relationships between modules and sub-modules are shown, although this relationship is not followed all the way down.

Appendix 1: CVM Definitions

The following table lists and describes some of the terms commonly referred to in this Detailed Description section. The definitions cover the specific implementation described and hence should not be construed as limiting more expansive definitions given elsewhere in this specification.

| Term | Description |
|---|---|
| ASIC | Application-Specific Integrated Circuit. |
| | An integrated circuit designed to perform a particular |
| | function by defining the interconnection of a set of basic |
| | circuit building blocks, which are taken from a library |
| | provided by a circuit manufacturer. |
| Assembly | An assembly of devices, derived devices, other assemblies |
| | and buses, which defines their connectivity. |
| Baseband | A telecommunication system in which information is |
| | superimposed, where the frequency band is not shifted |
| | but remains at its original place in the electromagnetic |
| | spectrum. |
| Behavioural Simulator | A simulator that allows a developer to explore how a |
| | particular function may perform within a system but |
| | without actually generating the detailed design |
| | configuration (in the case of a DSP, its software) for the |
| | target device. A behavioural model ensures that inputs |
| | and outputs are accurate but the internal implementation |
| | is created in a different way to the hardware it is |
| | attempting to model. RadioScape's initial behavioural |
| | simulator is the RadioLab3G product that supports the |
| | W-CDMA FDD standard. |
| Bit True | Accurately reflecting the behaviour of a particular |
| | implementation. Every bit of data output is identical to |
| | that which would be generated by a hardware |
| | implementation of the function being modelled. |
| CSV | Comma Separated Values. |
| | Text based format for a data file with fields separated by |
| | commas. |
| CVM | Communication Virtual Machine ™. |
| | RadioScape's CVM methodology produces a Runtime |
| | Kernal that handle resource management, hardware |
| | abstraction and scheduling. The CVM Runtime Kernel is |
| | deployed through the use of RadioScape's CVM Toolset. |
| COM | Component Object Model. |
| | Microsoft's mechanism to allow one piece of software to |
| | call services supplied by another, regardless of their |
| | relative locations. Usually distributed as DLL files. |
| Conformance Test | A test to establish whether an implementation of an |
| | Engine matches the functionality of its Reference engine |
| | behavioural equivalent. |
| | This test is executed by the EDK as a plug-in to the |
| | semiconductor vendor supplied integrated development |
| | environment. Both the particular fixed-point polymorph |
| | of the behavioural model and the proposed |
| | implementation are simulated with the same stimulus |
| | vectors and the results compared. In some cases the |
| | comparison is a simple matching of numbers whereas in |
| | others it is necessary to evaluate whether the |
| | implementation equals or betters the performance of the |
| | behavioural equivalent. |
| CVMGen | A tool in the CVM family for generating stub code for |
| | engines. |
| Cycle Accurate Simulator | A simulator that is dedicated to accurately modelling the |
| | behaviour of a particular hardware implementation. The |
| | data output is accurately represented at each clock cycle |
| | and contains knowledge of the impact of cache memory, |
| | pipeline and look-ahead, etc. This type of simulation, by |
| | its very nature, takes requires considerable processing |
| | power to perform and so is only suitable for short |
| | simulation runs. |
| Data Type | The data type that can be used by a parameter. |
| Deployment | A Layer-1 system based on the CVM Runtime Kernel |
| | which can be developed using the CVM Toolset. |
| DLL | Dynamic Linked Library. |
| | A type of library that becomes linked to a program that |
| | uses it only temporarily when the program is loaded into |
| | memory or executed rather than being permanently built |
| | in at compilation time. |
| Dorsal Connection | Control Input connection on Planes or Modules |
| DSP | Digital Signal Processing. |
| | Computer manipulation of analogue signals that have |
| | been converted to digital form (sampled). Spectral |
| | analysis and other signal processing functions are |
| | performed by specially optimised Digital Signal |
| | Processors. Digital Signal Processors are super versions |
| | of RISC/maths co-processors in VLSI (Very Large Scale |
| | Integration) chip form, although they differ from maths |
| | co-processors in that they are independent of the host |
| | computer and can be built into a standalone unit. Like |
| | RISC, they depend on a small core of instructions that |
| | are optimised at the expense of a wider set. They are |
| | often capable of special addressing modes that are unique |
| | to a particular application. |
| Engine | A particular type of high resource function that has been |
| | Conformance tested and Performance profiled with |
| | EDK. |
| | Such a function usually consumes significant processor |
| | cycles and/or memory; common examples include a Fast |
| | Fourier Transform, Finite Input Response Filter and |
| | Complex Vector Multiply. Specifically an Engine is |
| | invoked in a standardised way and with a standardised |
| | approach to data marshalling. Access to RTOS functions |
| | is normalised through RadioScape's CVM Runtime |
| | Kernel. An Engine runs an Algorithm to implement a |
| | particular transform. An Engine is the lowest level of |
| | code class element within the RadioScape programming |
| | model for Layer-1. |
| Engine Co-Class | The Engine Co-Class is responsible for passing requests |
| | through to the underlying implementation, while also |
| | ensuring that, for example, all appropriate memory |
| | allocation invariants are met. It conforms to the Engine |
| | Type interface. |
| EDK | Engine Development Kit. |
| | RadioScape's tool for introducing new Engines to the |
| | RadioScape environment. Configured as a plug-in to the |
| | semiconductor vendor's code development tool. |
| | Certifies the Conformance to a polymorphic ‘gold’ |
| | standard behavioural model and Performance |
| | characteristics of an Engine. Following performance |
| | testing the characteristics may be substituted for low- |
| | level simulation within the Predictive Simulator. |
| Engine Interface | The Engine Interface describes the format of the calls |
| | that the engine must handle. |
| FFT | Fast Fourier Transform. |
| | An algorithm to convert a set of uniformly spaced points |
| | from the time domain to the frequency domain. |
| FIR | Finite Impulse Response. |
| | A type of digital signal filter, in which every sample of |
| | output is the weighted sum of past and current samples |
| | of input, using only a finite number of past samples. |
| Fixed Point | A number representation scheme in which a fixed |
| | number of bits are used to represent a numerical value. |
| | Calculations using this method are subject to inaccuracy |
| | due to the difference between approximate |
| | representations with a limited number of bits turning |
| | every number, including fractions, into integers. |
| | This mode is important on the RadioLab3G tool since it |
| | enables the behavioural models to more accurately |
| | represent the limitations of the physical implementation. |
| Flip Flop | A digital logic circuit that can be in one of two states, |
| | which its inputs cause it to switch between. |
| Forward Declared Engines | The process of providing the Performance Certificate for |
| | an engine, together with estimated values, in order to |
| | perform stochastic simulation before engine construction |
| | is complete. |
| | Once engine construction is complete, the forward |
| | declared Engine can be replaced by a Performance |
| | Certificate derived from a real engine implementation. |
| FPGA | Field-Programmable Gate Array. |
| | A gate array, where the logic network can be |
| | programmed into the device after its manufacture. It |
| | consists of an array of logic elements: either gates or |
| | lookup table RAMs (Random Access Memory), flip-flops |
| | and programmable interconnect wiring. |
| Framework | A framework is a CVM Layer-1 application specific |
| | development. It may consist of a set of planes, modules |
| | and/or engines. |
| Reference engine Blocks | Polymorphic Fixed Point Bit-true Behavioural |
| | descriptions of high resource functions. |
| | These are effectively the behavioural versions of Engines. |
| | These Blocks come with a set of test vectors for |
| | Performance Testing and Conformance testing. A block |
| | is considered the Reference engine as it is used as the |
| | definitive statement of functionality. |
| Hardware End-Points | A hardware Engine is a dedicated physical |
| | implementation designed to perform a specific high |
| | resource function. Engines can be implemented in either |
| | hardware or software. Such an Engine may handle either |
| | Streaming implementations where data is continually |
| | processed without intervention, or Block implementation |
| | where fixed amounts of data are processed in each |
| | activation. RadioScape describes the necessary interfaces |
| | to be created to treat the block as a ‘hardware endpoint’. |
| | Such an end point may be substituted at a design time |
| | with either hardware or software implementations of an |
| | Engine. |
| Hardware-in-the-loop | At any point in either Engine or System Development |
| | behavioural or cycle accurate simulation models may be |
| | replaced by physical implementations of Engines running |
| | on representative silicon. |
| HRF | High Resource Function. |
| | A function within a Layer-1 implementation that has |
| | been identified as consuming substantial systems |
| | resources, usually processor cycles, and/or memory. |
| | Common examples include a Fast Fourier Transform, |
| | Finite Input Response Filter and Complex Vector |
| | Multiply. These functions are not usually specific to the |
| | wireless standard being implemented. An HRF that has |
| | been conformance and performance tested within EDK |
| | is referred to as an Engine. |
| IDE | Integrated Development Environment. |
| | A system that supports the process of developing |
| | software. This may include a syntax-directed editor, |
| | graphical entry tools, and integrated support for |
| | compiling and running software and relating compilation |
| | errors back to the source. |
| Inflate | This engine method enables you to give an identifying |
| | name for an allocation of memory along with the size |
| | you want the memory block to be. CVM can then track |
| | this memory so that you don't have to worry about it. |
| Layer-1 | First layer of the OSI seven layer Model. |
| | Layer-1 is the physical layer relating to signalling and |
| | modulation schemes. Typically in modern wireless |
| | standards these are implemented in digital signal |
| | processor devices (DSPs) and so will have high software |
| | content. |
| MIPS | Million Instructions Per Second. |
| | The unit commonly used to give the rate at which a |
| | processor executes instructions. |
| Module | Modules are aggregation elements that can contain an |
| | arbitrary number (>=0) of (sub-) modules and engines. |
| | Modules contain code, which can invoke these contained |
| | components, but which itself does not consume |
| | significant system resources, and so may be written in |
| | platform-independent C++. Data processing within a |
| | module runs imperatively once started, and the CVM |
| | runtime guarantees that at most one thread will ever be |
| | active within a given plane instance at any time. Modules |
| | have access to a more sophisticated memory model than |
| | engines, and may also send and receive control messages. |
| Parameter | One of the items of data that passes into or out of an |
| | engine. |
| Performance Certificate | Digital certificate that references an associated CSV file |
| | that holds a set of resource usage characteristics under |
| | different conditions for particular physical |
| | implementations of a high resource function. |
| | This data is generated by the Performance Test. |
| Performance Test | The aim of the performance test is to create a |
| | Performance Certificate that can be used with the |
| | Performance Simulator. The test involves executing a set |
| | of stimulus vectors against an Engine under test and |
| | recording the results. The test vectors aim to build up a |
| | set of points on a multi-dimensional surface that can later |
| | be interpolated to make useful estimates of execution |
| | time and resource usage. A key parameter, say data |
| | length, will be varied and the number of cycles recorded |
| | at each point. Key variables may be expanded to provide |
| | data for other variables such as bus loading, or other |
| | shared resources so creating a multi-dimensional profile. |
| | During Simulation the best estimate for resource |
| | utilisation is found by looking up the appropriate closest |
| | matches within the performance certificate and |
| | interpolating the result. This process is performed within |
| | the EDK plug-in. |
| Plane | Planes are top-level synchronisation objects that contain |
| | a single module, and which communicate using |
| | asynchronous message passing. |
| Plug-in | A small program that adds extra function to some larger |
| | application. EDK operates as a plug-in to the vendor's |
| | development tool environment. |
| Policy | A policy is used by schedulers to schedule data |
| | processing. |
| Polymorphic | Function that can be applied to many different data |
| | types. Used in this context to indicate the ability of |
| | behavioural blocks to operate at different bit widths |
| | internally and externally, and have different overflow |
| | behaviours. This is valuable in allowing behavioural |
| | models to more accurately represent the physical |
| | implementation. |
| PPO | Parameter Passing Option. |
| | These stipulate the seven main ‘modes’ in which a |
| | parameter may be passed into a method (namely: in, |
| | inout, out, incast/outcast, infree and inshared and |
| | outalloc). Core types T and arrays of core types can be |
| | passed as method arguments. |
| Python | A freeware interpreted Object Oriented Scripting |
| | Language used for creating test scripts of Performance |
| | and Conformance testing and the Stimulus for Predictive |
| | Simulation. See http://www.python.org |
| RadioLab3G | RadioScape's behavioural simulator supporting the |
| | W-CDMA FDD radio interface. The tool is based on |
| | Matlab/Simulink and uses the same ‘Gold’ standard |
| | blocks as the EDK conformance tool. |
| Rake | Digital section of a CDMA receiver which permits |
| | receiver to separate out the relevant signal from all the |
| | other signals. |
| RTOS | Real Time Operating System. |
| | A class of compact and efficient operating system for use |
| | in embedded systems. Relevant example include DSP |
| | BIOS, OSE, Virtex and VDK. The CVM Runtime |
| | Kernel normalises the presented functions of common |
| | RTOS products so that Engines can operate in a number |
| | of environments. |
| Re-entrant | Code that has multiple simultaneous, interleaved, or |
| | nested invocations, which do not interfere with each |
| | other. |
| Resource | The quantity of a resource type a specific element has. |
| RISC | Reduced Instruction Set Computer. |
| | A processor where the design is based on the rapid |
| | execution of a sequence of simple instructions rather |
| | than a large variety of complex instructions. Features |
| | which are generally found in RISC designs are: uniform |
| | instruction encoding, which allows faster decoding; a |
| | homogenous register set, allowing any register to be used |
| | in any context and simplifying complier design; and |
| | simple addressing modes with more complex modes |
| | replaced by sequences of simple arithmetic instructions. |
| Runtime | CVM Runtime is made up of both standard CVM |
| | Runtime components and application-specific, |
| | components designed by you. The standard CVM |
| | Runtime components provide the core Runtime |
| | functionality, common to all CVM applications. |
| SDCL | System Development Class Library. |
| | Allows users to build modules and planes, and then |
| | combine these into a system framework. It also provides |
| | an RTOS abstraction layer. |
| Simulation Run | The results of simulating a particular deployment using |
| | the simulator. |
| Stateful | To avoid context switching, RadioScape's Engines are |
| | stateful. This means they preserve their state information |
| | from one invocation to the next. Accordingly, it is not |
| | necessary to reconfigure parameters or prime data when |
| | the function is called. |
| Predictive Scheduling | The use of statistical information harvested at design |
| | time during a Training Run that enables runtime- |
| | scheduling decisions to be made more efficiently at |
| | runtime. |
| Stochastic Simulation | A type of simulation where certain functions rather than |
| | being modelled at a low granularity are replaced by |
| | statistically based estimates of time and resource usage. |
| | The resulting output while not data accurate is useful in |
| | understanding complex system performance in a short |
| | elapsed time simulation run. The Stochastic Simulator is |
| | part of the CVM System Development Kit. |
| UE | User Equipment. |
| | 3G terminology that emphasises that future user devices |
| | may not be simple voice handsets but may take different |
| | forms; wrist phone, car navigation device, camera, PDA, |
| | etc. |
| Ventral Connection | Control output connection on Planes and Modules |
| Viterbi | An algorithm to compute the optimal (most likely) state |
| | sequence in a hidden Markov model, given a sequence of |
| | observed outputs. |
| XML | eXtensible Markup Language. |
| | A simple SGML dialect. The goal of XML is to enable |
| | generic SGML to be served, received, and processed on |
| | the Web in the way that is now possible with HTML. |
| | While simpler than SGML, XML has a more flexible tag |
| | definition system than the format based tags used in |
| | HTML. This allows a far wider range of information to |
| | be stored and exchanged than is possible with HTML. |
| | Many CVM definitions are stored in XML file format. |
| | Refer to http://www.w3.org/XML/ |

1. A method of designing a system for real time digital signal processing, in which the system uses a virtual machine layer to separate (i) high resource functions from (ii) low resource control code that requests execution of the high resource functions, wherein the method comprises the step of partioning the system along its scheduling boundaries and assigning a software entity (“a plane”) to each partioned area such that scheduling is performed in respect of planes.

2. The method of claim 1 in which the scheduling boundaries comprise one or more of the following: framing, timing, and instantiation boundaries

3. The method of claim 1 in which planes communicate with one another asynchronously using messages.

4. The method of claim 3 in which a plane can process only one message at a time and pending messages for that plane are queued.

5. The method of claim 3 in which all messages are time stamped and identified to a time domain.

6. The method of claim 3 in which there are separate data and control paths between planes.

7. The method of claim 1 in which a plane is a hierarchical object that holds modules, in which a module can hold an arbitrary number of modules, sub-modules and high resource functions.

8. The method of claim 7 in which modules in a plane communicate synchronously.

9. The method of claim 7 in which a module encapsulates an imperative, single threaded data flow path.

10. The method of claim 1 in which planes can be dynamically created and destroyed.

11. The method of claim 1 in which one or more of the following standardised, pre-fabricated planes are available to the designer:
(a) multiplexing;
(b) demultiplexing;
(c) multicast;
(d) routing;
(e) active source;
(f) active sinks.

12. The method of claim 1 in which a plane has one or more input ports for receiving data messages and one or more output ports for sending data messages.

13. The method of claim 1 in which a plane has one input control port for receiving control messages and one output control port for sending control messages.

14. A device capable of real time digital signal processing, in which the device uses a virtual machine layer to separate (i) high resource functions from (ii) low resource control code that requests execution of the high resource functions, wherein the device comprises has been partioned along its scheduling boundaries and a software entity (“a plane”) has been assigned to each partioned area such that scheduling is performed in respect of planes.
